(19) United States
(12) Patent Application Publication
(10) Pub. No.: US 2026/0340275 A1
(43) Pub. Date: Oct. 29, 2026

(54) SYSTEMS AND METHODS FOR MANAGING DOCUMENTS WITH REVISIONS

(71) Applicant: PALANTIR TECHNOLOGIES INC., Denver, CO (US)

(72) Inventors: Abhiram Tamvada, Cranbury, NJ (US); Jonathan Liu, South Bend, IN (US); Raphael Charriez, New York, NY (US); Ranec Highet, New York, NY (US)

(21) Appl. No.: 19/205,235

(22) Filed: May 12, 2025

Related U.S. Application Data
(60) Provisional application No. 63/796,634, filed on Apr. 29, 2025.

(51) Int. Cl. G06F 40/197; G06F 16/906; G06F 16/93

(52) U.S. Cl. CPC G06F 40/197; G06F 16/906; G06F 16/93

(57) ABSTRACT

In some examples, systems and methods for managing documents with revisions are provided. An example method includes receiving a document. In some examples, the document includes one or more sections. In some examples, each section of the one or more sections has one or more text strings. In some examples, the method includes identifying a document classification associated with the document, selecting a hierarchical data model based on the document classification, generating a request based on the document and an indication of the hierarchical data model, providing the request to a large language model, and receiving a hierarchical representation corresponding to the document from the large language model. In some examples, the hierarchical representation includes an indication of a document object and one or more section objects. In some examples, each section object of the one or more section objects is linked to the document object and each section object includes data associated with a respective section of the one or more sections.

This application claims the benefit of U.S. Provisional Application No. 63/796,634, filed Apr. 29, 2025, which is incorporated by referenced herein for all purposes.

### TECHNICAL FIELD

Certain embodiments of the present disclosure relate to managing documents. More particularly, certain embodiments of the present disclosure relate to managing documents with revisions.

### BACKGROUND

Document management systems can provide a way to organize documents. The documents may be revised over time.

Hence, it is desirable to improve techniques for managing documents with revisions.

### SUMMARY

Certain embodiments of the present disclosure relate to managing documents. More particularly, certain embodiments of the present disclosure relate to managing documents with revisions.

At least some aspects of the present disclosure are directed to a method for generating a hierarchical representation of document versions. In some examples, the method includes receiving a document. In some examples, the document includes one or more sections. In some examples, each section of the one or more sections has one or more text strings. In some examples, the method includes identifying a document classification associated with the document, selecting a hierarchical data model based on the document classification, generating a request based on the document and an indication of the hierarchical data model, providing the request to a large language model, and receiving a hierarchical representation corresponding to the document from the large language model. In some examples, the hierarchical representation includes an indication of a document object and one or more section objects. In some examples, each section object of the one or more section objects is linked to the document object. In some examples, each section object includes data associated with a respective section of the one or more sections. In some examples, the method is performed using one or more processors.

At least some aspects of the present disclosure are directed to a system for generating a hierarchical representation of document versions. In some examples, the system includes one or more processors and one or more memories storing instructions that, when executed by the one or more processors, cause the system to perform a set of operations. In some examples, the set of operations includes receiving a document. In some examples, the document includes one or more sections. In some examples, each section of the one or more sections has one or more text strings. In some examples, the set of operations includes identifying a document classification associated with the document, selecting a hierarchical data model based on the document classification, generating a request based on the document and an indication of the hierarchical data model, providing the request to a large language model, and receiving a hierarchical representation corresponding to the document from the large language model. In some examples, the hierarchical representation includes an indication of a document object and one or more section objects. In some examples, each section object of the one or more section objects is linked to the document object. In some examples, each section object includes data associated with a respective section of the one or more sections.

At least some aspects of the present disclosure are directed to a non-transitory computer-readable storage medium with instructions that when executed by one or more processors cause the one or more processors to perform a set of operations. In some examples, the set of operations includes receiving a document. In some examples, the document includes one or more sections. In some examples, each section of the one or more sections has one or more text strings. In some examples, the set of operations includes identifying a document classification associated with the document, selecting a hierarchical data model based on the document classification, generating a request based on the document and an indication of the hierarchical data model, providing the request to a large language model, and receiving a hierarchical representation corresponding to the document from the large language model. In some examples, the hierarchical representation includes an indication of a document object and one or more section objects. In some examples, each section object of the one or more section objects is linked to the document object. In some examples, each section object includes data associated with a respective section of the one or more sections.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 illustrates a simplified diagram showing a method for managing documents with revisions, according to certain embodiments of the present disclosure.

FIG. 2 illustrates a simplified diagram showing a method for managing documents with revisions, according to certain embodiments of the present disclosure.

FIG. 3 illustrates an example system for managing documents with revisions, according to certain embodiments of the present disclosure.

FIG. 4 illustrates an example user interface, according to certain embodiments of the present disclosure.

FIG. 5 illustrates an example user interface, according to certain embodiments of the present disclosure.

FIG. 6 illustrates an example user interface, according to certain embodiments of the present disclosure.

FIG. 7 illustrates an example user interface, according to certain embodiments of the present disclosure.

FIG. 8 illustrates an example user interface, according to certain embodiments of the present disclosure.

FIG. 9 illustrates a simplified diagram showing a computing system for managing documents with revisions, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods are very inefficient and/or unreliable for querying a current version of a section of a document (e.g., a clause or appendix table) at a given time, when the document has undergone a plurality of amendments. For example, conventional systems often rely on manual processes that are time-consuming and inefficient, particularly when handling large amounts (e.g., thousands, millions, billions, etc.) of documents. Conventional systems may require manually reading the documents and all the amendments to the documents to track changes to the documents. Additionally, some conventional systems do not have querying capabilities that allow a user to ask questions about the document. For example, searching for particular sections of a document and extracting information can require extensive reading and manual work relying on conventional systems.

Various embodiments of the present disclosure can achieve benefits and/or improvement by a computing system for managing documents with revisions. In some embodiments, benefits include improved accuracy for organizing versions of documents with a plurality of sections and amendments to one or more of the plurality of sections. For example, by using a large language model to classify documents from a collection of documents into an initial document category and an amendment category, embodiments disclosed herein can generate a hierarchical representation of the document versions. In some embodiments, such functionality can significantly improve the accuracy with which document versions are organized.

In some examples, techniques provided herein provide the benefit of structuring large quantities of unstructured data from disparate data sources. In some examples, by reliably structuring the previously unstructured data, innovative technical functions can be implemented that improve a user's experience, such as generating visual timelines of amendments to a document and/or sections thereof, searching live documents from particular moments in time, summarizing live documents and/or changes between live documents from different periods of time, and/or integrating artificially intelligent agentic functionality for downstream actions based on the hierarchical representation. Additional and/or alternative benefits should be recognized by those of ordinary skill in the art, at least in light of the teachings provided herein.

In some embodiments, a document management system is provided. In some embodiments, the document management system includes access-controlled versioning and querying capabilities. In some embodiments, the documents are contracts with a plurality of clauses and a plurality of amendments that include additions to, deletions of, and/or revisions to at least one clause of the plurality of clauses.

In some embodiments, systems disclosed herein improve upon conventional document management software (e.g., contract management software) that lack version control solutions. In some embodiments, contract clauses and/or table are stored in the form of a contract document, such as followed by a series of amendment documents. Using conventional systems and methods there may be no way to reliably query a current version of a specific clause or appendix table at a given time (e.g., date, time of day, etc.), without manually reading contracts and all their amendment documents. In some embodiments, techniques disclosed herein improve over conventional systems and methods by offering a view into the live state of a contract at any effective date and/or time.

Conventional document management systems and methods also lack advanced querying capabilities. For example, in some conventional document management systems, searching for clauses and extracting information for contracts requires extensive reading and manual work. In some embodiments, using a clause object in a hierarchical representation of objects and large language models (LLMs), systems disclosed herein allow users to make specific queries (e.g., questions) about their contracts to artificially intelligent agents.

In some embodiments, systems disclosed herein include data pipelines that lead to object-based structures to hold document data. For example, the object-based structures corresponding to document data can be created through custom data transforms in an object oriented programming language (e.g., Java, Python, etc.). In some embodiments, the custom data transforms are ran on top of different worker processes (e.g., spark executors) that also run custom functions for optical character recognition (OCR) to conduct text extraction. In some embodiments, systems disclosed herein use the same or another style of transforms for object relational data modeling and indexing.

In some embodiments, systems disclosed herein include retrieval augmented generation (RAG) to improve chat functionality. In some embodiments, in generative artificial intelligence (e.g., LLMs), RAG is a technique that combines retrieval-based and generation-based models to improve response accuracy and relevance. For example, RAG can enhances language model outputs by fetching relevant external documents or knowledge sources before generating an answer, thereby reducing hallucinations and enabling more informed (e.g., accurate) responses.

In some embodiments, systems disclosed herein include a robust data pipeline built on a worker process (e.g., spark executor) running custom transforms to split documents into fundamental components (e.g., sections and amendments). For example, if the documents are contracts, the transforms can split the contracts into amendments and clauses. In some embodiments, the systems can parse the split sections (e.g., clauses) automatically with the worker processes running custom functions to allow automatic categorization of the sections and amendments. In some examples, the categorization is performed using an LLM, such as GPT 3, GPT 3.5, GPT 4, etc. Additional and/or alternative LLM models will be recognized by those of ordinary skill in the art. In some embodiments, deterministic functions can be used (e.g., in combination with LLM functions) to extract information from documents without loss of certain details.

In some embodiments, particular ontology of the disclosed system allows for the ability to link between data lakes of unstructured text, and enrich that data with structured metadata. In some embodiments, techniques disclosed herein bring disparate ingested data into an interconnected, easily queried data source. In some embodiments, this structure then allows for a flexible and robust platform to be built with a plurality of different features with which users may interact (e.g., via a graphical user interface). In certain embodiments, an ontology refers to a structural framework (e.g., object models) containing information and data related to objects and relationships of objects (e.g., functions applicable to objects, links) within a specific domain (e.g., an organization, an industry). In some embodiments, an action refers to one or more processing logics applied to one or more objects including, for example, creating objects, changing objects, combining objects, linking objects, deleting objects, and/or the like. In certain embodiments, ontologies include object types, action types, and link types, collectively referred to as object types.

In certain embodiments, an action can be represented by an instance of the action type, where the instance of the action type includes data associated with the action occurring and using the action type data structure. In some embodiments, an object type is a data structure representing a type of an object, where the data structure includes one or more object properties. In some embodiments, an object type is a software structure (e.g., metadata, an object structure, etc.) that can be instantiated as one or more objects of the object type.

In some embodiments, the system includes an effective date contracts functionality. For example, a user can pick any given date and see what clauses were in effect on a given date, drastically reducing time needed to figure out what clauses were in effect for a given dispute. In some embodiments, users are able to leverage a custom function to generate a document that contains the effective clauses of the contract, such as in a portable document format (PDF), word processing document, or other electronic document format. In some examples, the custom function is built on a worker process (e.g., an executor).

In some embodiments, the system includes a document timeline review functionality. For example, a user can visualizes changes to their document over time with a timeline view that flags what clauses have changed between version. In some examples, a user can visualize, via the document timeline review functionality, which clauses have been deleted. In some embodiments, users have the option to select versions of the contract and automatically examine specific exhibits between the two versions to point out key differences.

In some embodiments, the system includes a clause write-back functionality. For examples, the system can leverage its data infrastructure to efficiently create an access-controlled write-back system. In some embodiments, the clause write-back functionality allows users to edit clauses within a user interface of an online platform and have the clauses update the online platform in a way that allows the user to both see changes made, and extract them to send to relevant parties. In some embodiments, contracts are sensitive data, and the online platform includes permissions system allows granular access control for contract reading and editing.

In some embodiments, the system includes an OCR-based document flagging functionality. For example, the system can include computer vision models and LLMs in order to flag quality of documents and prompt users to upload better versions of the document in order to ensure users see data with relatively high integrity.

In some embodiments, the system includes a chat with document functionality. In some embodiments, leveraging LLMs powered by complex queries and a RAG-based workflow with a custom data pipeline and functions running on work processes (e.g., a spark-executor), the systems include the ability for users to chat with a user interface about their document and extract any key specific pieces of information, such as with custom workflows.

In some embodiments, systems disclosed herein can be applied to contracts with clauses. In some embodiments, systems disclosed herein can be applied to other types of documents with sections, such as purchase orders, financial statements, marketing materials, business reports, books, and/or other types of documents that may be recognized by those of ordinary skill in the art.

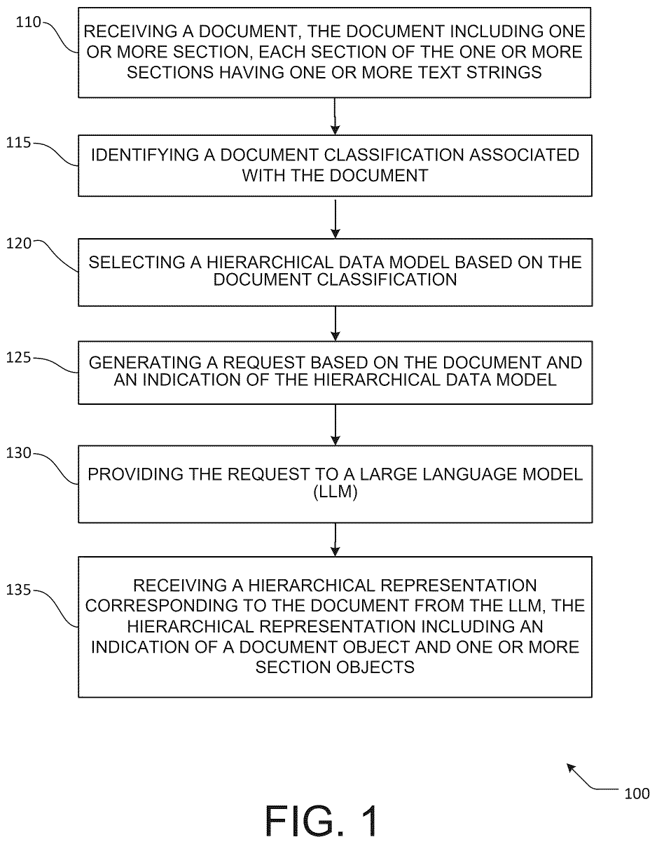

FIG. 1 is a simplified diagram showing a method 100 for managing documents with revisions according to certain embodiments of the present disclosure. This diagram is merely an example. One of ordinary skill in the art would recognize many variations, alternatives, and modifications. The method 100 for managing documents with revisions includes processes 110, 115, 120, 125, 130, and 135. Although the above has been shown using a selected group of processes for the method 100 for managing documents with revisions, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 100 are performed by a system (e.g., the computing system 900). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at the process 110, a document is received. In some examples, the document includes one or more sections. In some examples, the document includes a plurality of sections. In some examples, each section of the document has one or more text strings. For example, the document can undergo object character recognition and/or another type of visual processing technique recognized by those of ordinary skill in the art, to extract text from the document. In some examples, the document corresponds to a physical document (e.g., a document that has been scanned, photographed, or otherwise converted from a physical document to a digital document).

In some examples, the document is a plurality of documents. For examples, the plurality of documents can include a first document that includes a plurality of sections and a second document that includes an amendment to at least one section of the plurality of sections. In some examples, the plurality of documents include a contract, a financial statement, a supply chain form, a marketing material, a book, an article, and/or another type of document that may be recognized by those of ordinary skill in the art as having a plurality of sections that may be amended over time.

In some examples, each document of the plurality of documents includes one or more text strings (e.g., text content). For example, each section of the plurality of sections can include respective text strings (e.g., text content). In some examples, the received document is a second document that is a revision (e.g., amendment) of a first document. For example, the revision can include an addition to the first document, a deletion from the first document, and/or an edit to content of the first document.

In some examples, the document is a contract and each section of the one or more sections is a respective clause of the contract. For examples, the clauses of the contract can specify parties to the contract, goods/services being purchased, a cost of the goods/services, a duration of the contract, an alternative dispute resolution process, a jurisdiction for disputes, a choice of law, an indemnification clause, an act of god clause, a severability clause, a damages clause, and/or other types of information that may be recognized by those of ordinary skill in the art.

According to some embodiments, at the process 115, a document classification associated with the document is identified. For example, the document can be classified into an initial document category or an amendment category (e.g., because the document is an amendment to an initial document). In some examples, the document is classified using an LLM and based on the text strings in the document. For example, by understanding the content and/or semantic context of the document, the LLM can determine whether the document has a higher probability of being an initial document or an amendment to an initial document. In some examples, the text strings in the document are provided to the LLM with a prompt that has been engineered to instruct the LLM on how to perform the classification on the document.

In some examples, prior to identifying the document classification, the process 100 includes determining a visual quality level of the document. For example, visual processing may be performed on the document to calculate a score of its visual quality. In some examples, the score for its visual quality can be based on a resolution (e.g., number of pixels per unit of area) of the document, a contrast between pixels of the document, and/or other visual quality metrics that may be recognized by those of ordinary skill in the art. In some examples, the visual quality level is compared to a predetermined threshold. In some examples, a user is prompted to provide a new version of the document with a higher visual quality level than the determined visual quality level. Generally, in some examples, prompting a user to provide a document with improved visual quality can improve the accuracy and efficiency of processes described herein. In other words, in some examples, documents with poor visual quality can negatively impact the accuracy and efficiency of processes described herein.

According to some embodiments, at the process 120, a hierarchical data model is selected based on the document classification. In some examples, the selecting of the hierarchical data model includes generating the hierarchical data model based on the document and the document classification. In some examples, the hierarchical data model is a graph and/or table. In some examples, the hierarchical data model includes different types of nodes (e.g., based on the document classifications of process 115). In some examples, the different types of nodes are linked together in particular configurations. In some examples, the hierarchical data model includes configurations for what types of data are stored in particular types of nodes. For example, an initial document node can include a copy of an initial document, a link to an initial document, a number of sections in the document, one or more links to sections in the document, a number of related documents (e.g., notices, letters, etc.), one or more links to the related documents, and/or other types of content that may be recognized by those of ordinary skill in the art.

According to some embodiments, at the process 125, a request is generated based on the document and an indication of the hierarchical data model. For example, the request can be a text prompt engineered to provide a desired result from an LLM. In some examples, the text prompt is prepared automatically by a model trained to draft the text prompt using parameters including the document and the indication of the hierarchical data model.

According to some embodiments, at the process 130, the request is provided to an LLM. For example, the request can be provided to a user interface in communication with an LLM. In some examples, the request can be provided to the LLM via an API, such as by providing the request as a parameter to a call sent to an API library corresponding to the LLM.

According to some embodiments, at the process 135, a hierarchical representation is generated corresponding to the document. In some examples, the hierarchical representation is received from the LLM. In some examples, the hierarchical representation includes an indication of a document object and one or more section objects. In some examples, each section object of the one or more section objects is linked to the document object. In some examples, each section object includes data associated with a respective section of the one or more sections. In some examples, when the received document includes a revision document, the hierarchical representation includes a revision object. In some examples, the revision object is linked to at least one of the one or more section objects and/or to the document object.

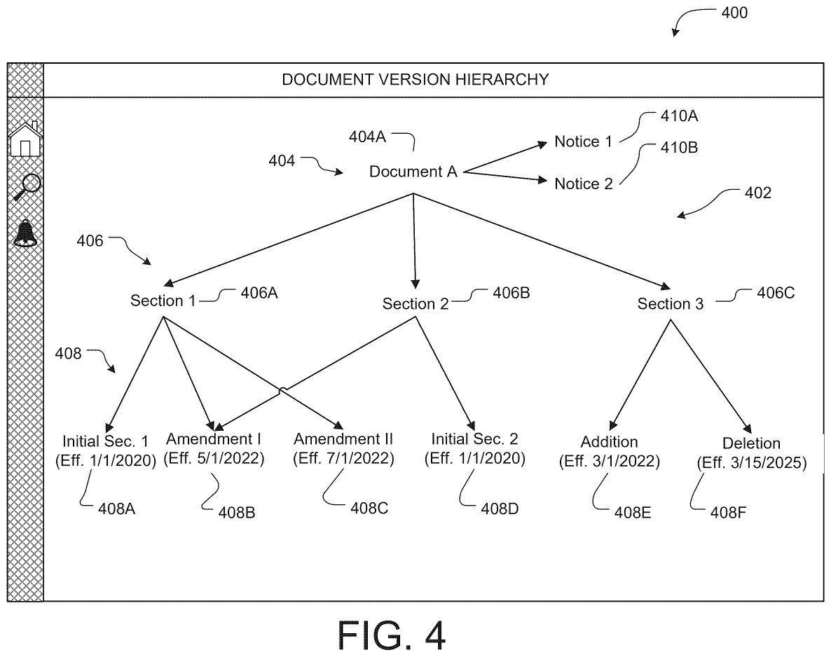

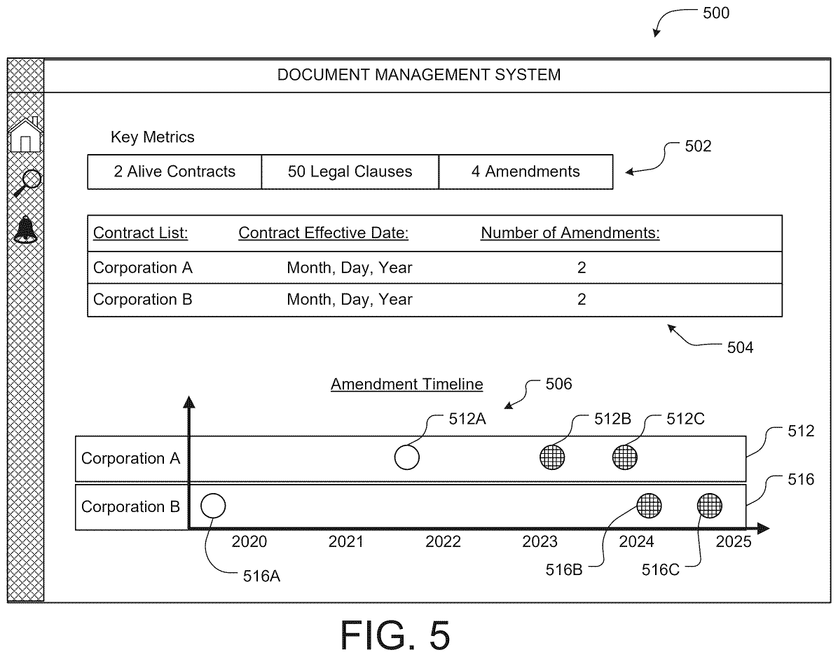

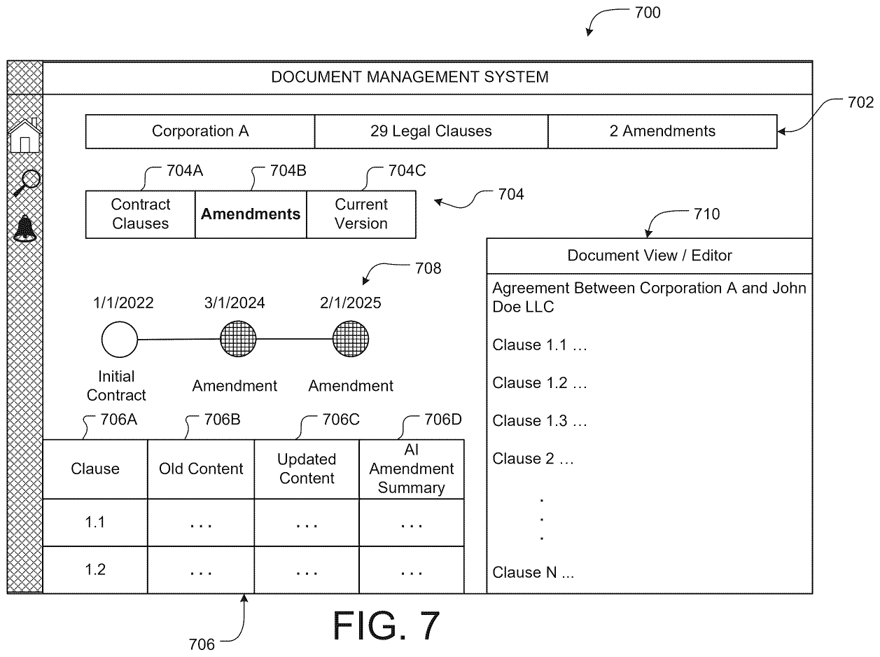

In some examples, a graphical user interface is displayed that includes information about the document based on the hierarchical representation. For example, certain examples of the graphical user interface are illustrated with respect to FIGS. 4-8. In some examples, the information displayed on the graphical user interface includes a timeline of one or more amendments made to the document (see e.g., FIG. 5 and FIG. 7). In some examples, the information includes one or more summaries describing the one or more amendments made to the document (see e.g., FIG. 7). For example, the one or more summaries can be generated by the LLM, such as providing content of the document, both prior to and after the amendment was effective, to the LLM.

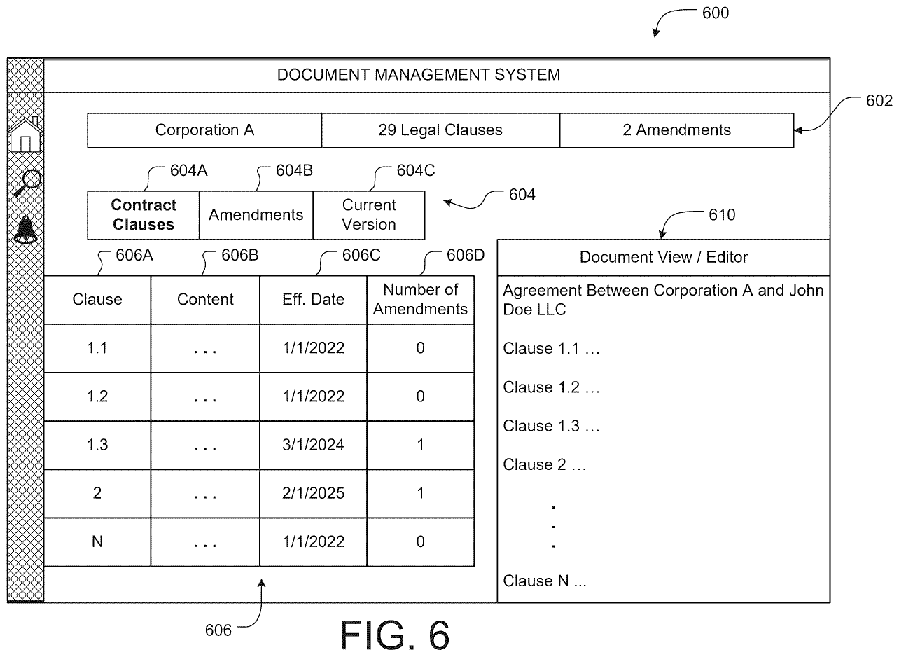

In some examples, a request is received for a current version of the document (e.g., contract) at a given date. For example, mechanisms provided herein can allow a user to receive (e.g., view) a live document (e.g., an aggregation of all of the current sections of the document for a given date). In some examples, the user could be interested in what versions of a document were current on a given date, such as in view of multiple revisions (e.g., amendments) being made to the contract over time. In some examples, the user can provide the date of inquiry to a computer system as user-input, such as via a voice command, text entry, option selection, and/or any other type of user input that may be recognized by those of ordinary skill in the art. In some examples, the current version of the document on the given date can be generated, based on the hierarchical representation. In some examples, a representation (e.g., visual display) of the current version of the document on the given date is provided (see e.g., FIGS. 6-8).

In some examples, a query is received regarding the document. For example, a user may provide input to a user interface (e.g., voice input, text input, a selection, gaze input, etc.) indicative of a query. In some examples, the hierarchical representation and the query are provided to the LLM. In some examples, a response to the query is received from the LLM. In some examples, the response to the query is provided, such as to a user. For example, the response may be output as audio and/or visually displayed, such as on a graphical user interface.

In some embodiments, method 100 may terminate at process 135. In some embodiments, method 100 may return to process 110 (or any other process from method 100) to provide an iterative loop, such as of receiving one or more documents, classifying the documents as initial version of the documents or revisions to the documents, generating a hierarchical representation corresponding to the one or more documents, and/or performing functions such as query-answering, version searching, and/or visual graphic generating using the hierarchical representation. As discussed above and further emphasized here, FIG. 1 is merely an example. One of ordinary skill in the art would recognize many variations, alternatives, and modifications.

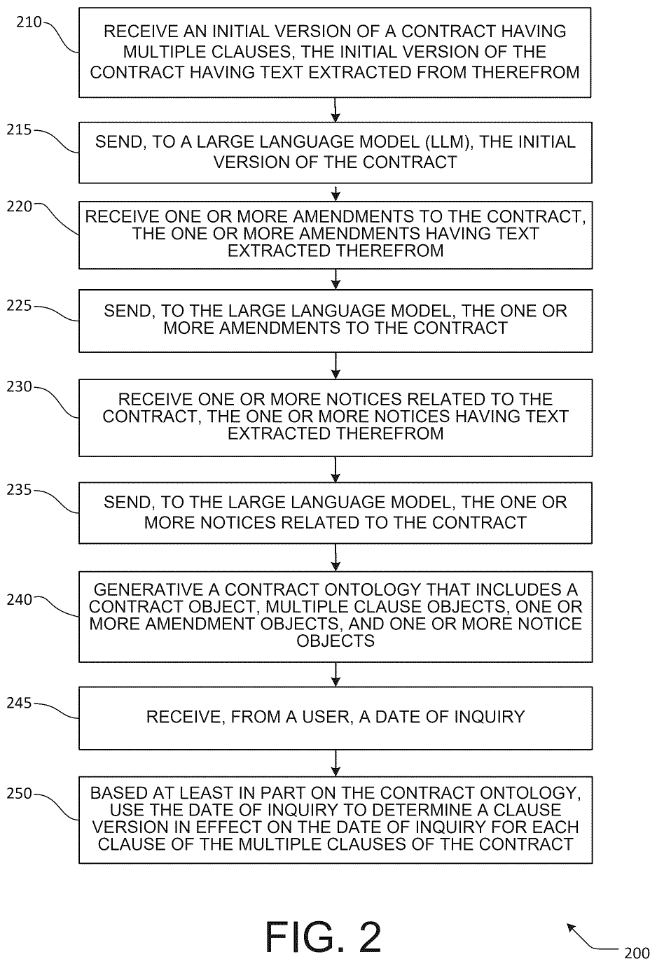

FIG. 2 is a simplified diagram showing a method 200 for managing documents with revisions according to certain embodiments of the present disclosure. This diagram is merely an example. One of ordinary skill in the art would recognize many variations, alternatives, and modifications. The method 200 for managing documents with revisions includes processes 210, 215, 220, 225, 230, 235, 240, 245, and 250. Although the above has been shown using a selected group of processes for the method 200 for managing documents with revisions, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 200 are performed by a system (e.g., the computing system 900). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at the process 210, a copy of an initial (e.g., executed) version of a contract is received. In some examples, the copy of the initial version of the contract has text extracted therefrom. For example, text of the initial version can be extracted via optical character recognition and/or another type of visual processing recognized by those of ordinary skill in the art.

In some examples, the initial version of the contract is associated with an initial effective date (e.g., a date when the contract was signed by parties to the contract). In some examples, the initial version of the contract includes multiple clauses. For example, the clauses can include an indemnification clause, a price clause, a duration clause, a choice of law clause, and/or another type of clause that may be recognized by those of ordinary skill in the art to be included in a contract, at least in light of the teachings provided herein.

According to some embodiments, at the process 215, the copy of the initial version of the contract with its text already extracted is sent to a LLM. For example, the initial version of the contract and/or an indication thereof can be provided to an application programming interface (API) that transmits the initial version of the contract and/or the indication thereof to the LLM.

According to some embodiments, at the process 220, one or more copies of one or more amendments (e.g., executed amendments) to the contract are received. In some examples, the one or more copies of one or more amendments have text extracted therefrom. For example, text of the copies can be extracted via optical character recognition and/or another type of visual processing recognized by those of ordinary skill in the art.

In some examples, the one or more amendments to the contract are associated with one or more amendment effective dates respectively. In some examples, each amendment of the one or more amendments includes one or more changes to one or more clauses of the multiple clauses of the contract. In some examples, at least one amendment of the one or more amendments includes an addition of a new clause to the one or more clauses of the multiple clauses of the contract. In some examples, at least one amendment of the one or more amendments includes a deletion of at least one clause of the multiple clauses of the contract.

According to some embodiments, at the process 225, the one or more copies of one or more amendments with their text already extracted are sent to the LLM. For example, the one or more copies of one or more amendments and/or an indication thereof can be provided to an application programming interface (API) that transmits the one or more copies of one or more amendments and/or the indication thereof to the LLM.

According to some embodiments, at the process 230, one or more copies of one or more notices (e.g., one or more letters) related to the contract are received. In some examples, the one or more copies of one or more notices have text extracted therefrom. For example, text of the copies can be extracted via optical character recognition and/or another type of visual processing recognized by those of ordinary skill in the art. In some examples, the one or more notices are associated with one or more notice dates respectively.

According to some embodiments, at the process 235, the one or more copies of one or more notices with their text already extracted are sent to the LLM. For example, the one or more copies of one or more notices and/or an indication thereof can be provided to an application programming interface (API) that transmits the one or more copies of one or more notices and/or the indication thereof to the LLM.

According to some embodiments, at the process 240, a contract ontology is generated. In some examples, the contract ontology includes a hierarchical representation. In some examples, the contract ontology includes a contract object, multiple clause objects, one or more amendment objects, and/or one or more notice objects.

In some examples, the contract ontology is generated by the LLM, such as by a user prompting the LLM causing it to generate the contract ontology. In some examples, the contract ontology is generated deterministically (e.g., via computer-readable instructions, such as written by a programmer). In some examples, aspects of the contract ontology can be generated by the LLM and aspects of the contract ontology can be generated deterministically.

In some examples, the contract object represents the contract. In some examples, the multiple clause objects represent the multiple clauses of the initial (e.g., executed) version of the contract respectively. In some examples, the one or more amendment objects represent the one or more amendments to the contract respectively. In some examples, the one or more notice objects represent the one or more notices related to the contract respectively.

In some examples, each clause object of the multiple clause objects includes initial texts (e.g., String values) of a corresponding clause and the initial effective date (e.g., as a String value and/or numerical value). In some examples, each amendment object of the one or more amendment objects includes texts of a corresponding amendment (e.g., as a String value) and a corresponding amendment effective date (e.g., as a String value and/or numerical value). In some examples, each notice object of the one or more notice objects includes texts of a corresponding notice (e.g., as a String value) and a corresponding notice date (e.g., as a String value and/or numerical value).

In some examples, each clause object of the multiple clause objects is linked to the contract object. For example, the clause objects may be linked to the contract object in a parent/child relationship, such as in a graph or hierarchical representation. In some examples, each notice object of the one or more notice objects is also linked to the contract object.

In some examples, each amendment object of the one or more amendment objects is linked to one or more clause objects of the multiple clause objects. In some examples, the one or more clause objects correspond to the one or more clauses to which the one or more changes are made by the amendment that corresponds to the amendment object. In some examples, each amendment object of the one or more amendment objects also includes one or more descriptions (e.g., remove, change, and/or add) for the one or more changes.

According to some embodiments, at the process 245, a date of inquiry is received from a user. For example, mechanisms provided herein can allow a user to receive (e.g., view) a live contract (e.g., an aggregation of all of the current clauses of the contract for a given date). In some examples, the user could be interested in what versions of a contract were current (e.g., effective) on a given date, such as in view of multiple revisions (e.g., amendments) being made to the contract over time. In some examples, the user can provide the date of inquiry to a computer system as user-input, such as via a voice command, text entry, option selection, and/or any other type of user input that may be recognized by those of ordinary skill in the art.

According to some embodiments, at the process 250, the date of inquiry is used, based at least in part on the contract ontology, to determine a clause version that is in effect on the date of inquiry for each clause of the multiple clauses. For example, the contract ontology can be traversed to determine which clause versions were current for the date of inquiry, and the current clause versions can be aggregated to determine what all of the current clause versions were on the date of inquiry.

In some examples, based at least in part on the clause version that is current (e.g., in effect) on the date of inquiry for each clause of the multiple clauses, a contract version that is current (e.g., in effect) on the date of inquiry for the entire contract can be generated. In some examples, the contract version that is current on the date of inquiry for the entire contract includes all of the multiple clauses of the contract that are current on the date of inquiry. For example, the aggregated current clause versions for all of the multiple clauses can be assembled into a document and the document can be presented to the user as the current contract version for the date of inquiry. In some examples, the contract version that is current (e.g., in effect) on the date of inquiry can be presented to a user, such as via a display and/or graphical user interface.

In some embodiments, method 200 may terminate at process 250. In some embodiments, method 200 may return to process 210 (or any other process from method 200) to provide an iterative loop, such as of receiving one or more versions of a contract, amendments to the contract, and/or notices related to the contract, updating a contract ontology, and determining current clause versions for given dates of inquiry. As discussed above and further emphasized here, FIG. 2 is merely an example. One of ordinary skill in the art would recognize many variations, alternatives, and modifications.

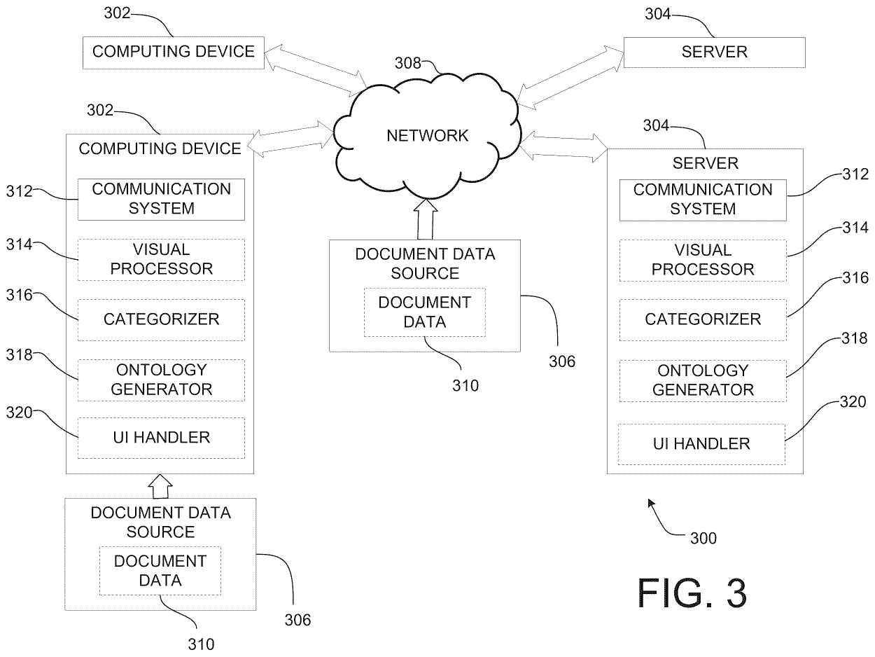

FIG. 3 shows an example of a system 300, in accordance with some aspects of the disclosed subject matter. In some embodiments, the system 300 is a system for managing documents with revisions. In some embodiments, the system 300 is a system for generating a hierarchical representation, such as of document versions. FIG. 3 is merely an example. One of the ordinary skilled in the art would recognize many variations, alternatives, and modifications. Although system 300 has been shown using a selected group of components, there can be many alternatives, modifications, and variations. For example, some of the components may be expanded and/or combined. Other components may be inserted into those noted above. Depending upon the example, the arrangement of components may be interchanged with others replaced. Further details of these components are found throughout the present disclosure.

In some embodiments, various components in the system 300 can execute software or firmware stored in non-transitory computer-readable medium to implement various processing steps. In some embodiments, various components and processors of the system 300 can be implemented by one or more computing devices including, but not limited to, circuits, a computer, a cloud-based processing unit, a processor, a processing unit, a microprocessor, a mobile computing device, and/or a tablet computer. In some embodiments, various components of the system 300 can be implemented on a shared computing device. In some embodiments, a component of the system 300 can be implemented on multiple computing devices. In some embodiments, various modules and components of the system 300 can be implemented as software, hardware, firmware, or a combination thereof.

In some embodiments, the system 300 includes one or more computing devices 302, one or more servers 304, one or more document data sources 306 for receiving document data 310, and a communication network or network 308. In some embodiments, the computing device 302 can receive document data 310 from the document data source 306. Additionally, or alternatively, in some embodiments, the network 306 can receive document data 310 from the document data source 306.

In some embodiments, computing device 302 includes one or more communication systems 312, one or more visual processors 314, one or more categorizers 316, one or more ontology generators 318, and/or one or more user interface (UI) handlers 320. In some embodiments, computing device 302 can execute at least a portion of the visual processor 314 to visually process one or more received documents. For example, the visual processor can apply an optical character recognition algorithm to extract text from the one or more received documents. In some examples, the visual processor 314 converts different types of documents, such as scanned paper documents or images of text, into editable and searchable digital text files. In some examples, the visual processor 314 uses machine learning models and/or computer vision to recognize characters (e.g., words) from the received documents.

In some embodiments, computing device 302 can execute at least a portion of the categorizer 316 to identify categories (e.g., labels) for the received documents, such as based on the text extracted by the visual processor. In some examples, the categories are identified and/or assigned using an LLM. For example, the extracted text can be provided to the LLM, such as with a pre-configured prompt, to cause the LLM to identify a category for the document from which the text was extracted.

In some embodiments, computing device 302 can execute at least a portion of the ontology generator 318 to generate an ontology of the plurality of documents, such as a graph, table, and/or hierarchical representation. For example, the categories assigned by the categorizer 316 can form one or more tiers of the ontology. In some embodiments, the ontology generator 316 can create a graphic for display on a user interface, which illustrates hierarchical relationships between one or more aspects of the document data 310.

In some embodiments, computing device 302 can execute at least a portion of the UI handler 320 to receive user input and perform associated functionality. For example, the UI handler 320 can receive queries from a user regarding the document data and generate responses to provide to the user. In some examples, the UI handler 320 interface with a large language model, to provide responses to the user, such as by providing a prompt to the LLM and/or the hierarchical representation. In some examples, the UI handler can generate summaries related to the document data, generate timelines based on the document data, display information requested from a user regarding the document data, and/or perform other functions that will be recognized by those of ordinary skill in the art at least in view of the present disclosure.

In some embodiments, server 304 includes one or more communication systems 312, one or more visual processors 314, one or more categorizers 316, one or more ontology generators 318, and/or one or more user interface (UI) handlers 320. In some embodiments, server 304 can execute at least a portion of the visual processor 314 to visually process one or more received documents. For example, the visual processor can apply an optical character recognition algorithm to extract text from the one or more received documents. In some examples, the visual processor 314 converts different types of documents, such as scanned paper documents or images of text, into editable and searchable digital text files. In some examples, the visual processor 314 uses machine learning models and/or computer vision to recognize characters (e.g., words) from the received documents.

In some embodiments, server 304 can execute at least a portion of the categorizer 316 to identify categories (e.g., labels) for the received documents, such as based on the text extracted by the visual processor. In some examples, the categories are identified and/or assigned using an LLM. For example, the extracted text can be provided to the LLM, such as with a pre-configured prompt, to cause the LLM to identify a category for the document from which the text was extracted.

In some embodiments, server 304 can execute at least a portion of the ontology generator 318 to generate an ontology of the plurality of documents, such as a graph, table, and/or hierarchical representation. For example, the categories assigned by the categorizer 316 can form one or more tiers of the ontology. In some embodiments, the ontology generator 316 can create a graphic for display on a user interface, which illustrates hierarchical relationships between one or more aspects of the document data 310.

In some embodiments, server 304 can execute at least a portion of the UI handler 320 to receive user input and perform associated functionality. For example, the UI handler 320 can receive queries from a user regarding the document data and generate responses to provide to the user. In some examples, the UI handler 320 interface with a large language model, to provide responses to the user, such as by providing a prompt to the LLM and/or the hierarchical representation. In some examples, the UI handler can generate summaries related to the document data, generate timelines based on the document data, display information requested from a user regarding the document data, and/or perform other functions that will be recognized by those of ordinary skill in the art at least in view of the present disclosure.

In some embodiments, computing device 302 and/or server 304 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some embodiments, there may be a plurality of computing device 302 and/or a plurality of servers 304.

In some embodiments, the document data source 306 can be any suitable source of document data (e.g., data generated from a computing device, data stored in a repository, data generated from a software application, data received via user input, etc.) In some embodiments, the document data 310 can be received from memory storing the document data 310 (e.g., local memory of computing device 302, local memory of server 304, cloud storage, portable memory connected to computing device 302, portable memory connected to server 304, etc.). In some embodiments, the document data source 306 can be an application configured to generate document data 310 and provide the document data 310 via a software interface. In some embodiments, the document data source 306 is a source local to computing device 302. In some embodiments, the document data source 306 is a source remote from computing device 302 and can communicate to computing device 302 (and/or server 304) via a communication network (e.g., communication network 308).

In some embodiments, the document data source 306 includes a repository implemented using any one of the configurations described below. In some embodiments, a data repository may include random access memories, flat files, XML files, and/or one or more database management systems (DBMS) executing on one or more database servers or a data center. In some embodiments, a database management system may be a relational (RDBMS), hierarchical (HDBMS), multidimensional (MDBMS), object oriented (ODBMS or OODBMS) or object relational (ORDBMS) database management system, and the like. In some embodiments, the data repository may be, for example, a single relational database. In some embodiments, the data repository may include a plurality of databases that can exchange and aggregate data by data integration process or software application. In some embodiments, at least part of the data repository may be hosted in a cloud data center. In some embodiments, a data repository may be hosted on a single computer, a server, a storage device, a cloud server, or the like. In some embodiments, a data repository may be hosted on a series of networked computers, servers, or devices. In some embodiments, a data repository may be hosted on tiers of data storage devices including local, regional, and central.

In some embodiments, the document data 310 includes a contract with a plurality of clauses. In some examples, the document data 310 includes an amendment document with an addition of, deletion of, and/or revision to a clause in a contract. In some examples, the document data includes a notice, a letter, a warranty, a contact, a purchase order, a product description, a product number, a vendor description, pricing, and/or quantities. In some examples, the document data includes text.

In some examples, when the document data includes a contract, the contract can include parties to the contract, goods/services being purchased, a cost of the goods/services, a duration of the contract, an alternative dispute resolution clause, a jurisdiction clause, an indemnification clause, an act of god clause, a severability clause, a damages clause, and/or other types of information that may be recognized by those of ordinary skill in the art.

In some examples, when the document data includes a purchase order, the purchase order can include product/service descriptions, product/service numbers, vendor descriptions, abbreviations, pricing, and quantities. For example, the product/service descriptions can include a name of a product/service, a representative image of a product/service, etc. In some examples, a vendor description can include a vendor's name, a vendor's address, a vendor's phone number, and/or a vendor's logo. Additional and/or alternative data that the document data 310 can include should be recognized by those of ordinary skill in the art.

In some embodiments, communication network 308 can be any suitable communication network or combination of communication networks. For example, communication network 308 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some embodiments, communication network 308 can be a local area network (LAN), interfaces conforming known communications standard, such as Bluetooth® standard, IEEE 802 standards (e.g., IEEE 802.11), a ZigBee® or similar specification, such as those based on the IEEE 802.15.4 standard, a wide area network (WAN), a public network (e.g., the Internet), a private or semi-private network (e.g., a corporate or university intranet), any other suitable type of network, or any suitable combination of networks. In some embodiments, communication links (arrows) shown in FIG. 3 can each be any suitable communications link or combination of communication links, such as wired links, fiber optics links, Wi-Fi links, Bluetooth® links, cellular links, satellite links, etc.

FIG. 4 illustrates an example user interface 400, according to certain embodiments of the present disclosure. In some examples, the user interface 400 is a graphical user interface (GUI). In some examples, the user interface 400 is displayed on a computing device, such as the computing device 302 of FIG. 3.

In some examples, the user interface 400 includes an ontology, graph, and/or hierarchical representation 402, such as may be generated using techniques described herein. In some examples, the hierarchical representation 402 is a tree. In some examples, the tree 402 includes a plurality of tiers, such as a first tier 404, a second tier 406, and a third tier 408. In some examples, the tree 402 can include additional and/or fewer tiers than those illustrated in FIG. 4. For example, in some embodiments, aspects of the third tier can be combined with aspects of the second tier, to form a single tier. In some examples, the hierarchical representation 402 can be a table, a pyramid, a graph, and/or another type of data structure capable of representing a hierarchy of objects.

In some examples, each tier 404-408 includes a plurality of nodes (e.g., objects). For example, the first tier 404 includes a first node 404A. As another example, the second tier 406 includes a first node 406A, a second node 406B, and a third node 406C. As another examples, the third tier 408 includes a first node 408A, a second node 408B, a third node 408C, a fourth node 408D, a fifth node 408E, and a sixth node 408F. Those of ordinary skill in the art should recognize that additional and/or alternative types of nodes, numbers of nodes, and/or connections between nodes may be present on other hierarchical representations generated in accordance with techniques provided herein.

In some examples, the first node 404A of the first tier 404 is a parent node of the first node 406A, the second node 406B, and the third node 406C of the second tier 406. In some examples, the first node 404A can include a label or identifier. For example, the label or identifier can be a label or identifier of a document that encompasses the first node 406A, the second node 406B, and the third node 406C of the second tier 406 (e.g., “Document A”). In some examples, the nodes (e.g., 404A) of the first tier 404 includes document objects. For example, the first node 404A of the first tier 404 can include a document object with an identifier of a document that has a plurality of sections. In some examples, the first node 404A of the first tier 404 includes an identifier of a contract that has a plurality of clauses.

In some examples, the first node 406A of the second tier 406 is a parent node of the first node 408A, the second node 408B, and the third node 408C of the third tier 408. In some examples, the first node 406A can include a label, category, or description that is broad enough to capture the semantic similarity (e.g., overarching abstract meaning) of the first node 408A, the second node 408B, and the third node 408C of the third tier 408 (e.g., “Section 1”, “Chapter 1”, “Title 1”, or “Clause 1”). In some examples, the second node 406B of the second tier 406 is a parent node of the second node 408B and the fourth node 408D of the third tier 408. In some examples, the second node 406B can include a label, category, or description that is broad enough to capture the semantic similarity (e.g., overarching abstract meaning) of the second node 408B and the fourth node 408D of the third tier 408 (e.g., “Section 2”, “Chapter 2”, “Title 2”, or “Clause 2”). In some examples, the third node 406C of the second tier 406 is a parent node of the fifth node 408E and the sixth node 408F of the third tier 408. In some examples, the third node 406C can include a label, category, or description that is broad enough to capture the semantic similarity (e.g., overarching abstract meaning) of the fifth node 408E and the sixth node 408F of the third tier 408 (e.g., “Section 3”, “Chapter 3, “Title 3”, or “Clause 3”).

In some examples, the nodes 406A-C of the second tier 406 include respective sections objects. For example, each node 406A-C can include a section object corresponding to a respective section of the plurality of sections of the document corresponding to the first node 404A of the first tier 404. In some examples, where the first node 404A of the first tier 404 corresponds to a contract, each node 406A-C of the second tier 406 can correspond to a respective clause of the contract.

In some examples, the nodes 408A-F each correspond to a version of the section with which they are linked. For example, the first node 408A of the third tier 408 includes an initial version of the section corresponding to the first node 406A of the second tier 406. In some examples, the nodes 408A-F each include a timestamp for their respective version. For example, the first node 408A of the third tier 408 has a timestamp of Jan. 1, 2020, indicating the initial version of Section 1 of Document A was effective, active, and/or current as of Jan. 1, 2020.

As another example, the second node 408B of the third tier 408 includes an amendment to both Section 1 and Section 2. For example, the second node 408B is linked to the first node 406A corresponding to Section 1 and to the second node 406B corresponding to Section 2. In some examples, the second node 408B includes a timestamp that is subsequent in time to the timestamp of the first node 408A because the second node 408B corresponds to an amendment to the first node 408A. For example, the second node 408B includes a timestamp of May 1, 2022, indicating revisions to Section 1 and Section 2 of Document A were effective, active, and/or current as of May 1, 2022.

In some examples, one or more nodes in the third tier 408 correspond to an addition and/or deletion. For example, the fifth node 408E of the third tier 408 indicates an addition with the timestamp of Mar. 1, 2022, indicating Section 3 was added to Document A on Mar. 1, 2022. As another example, the sixth node 408F of the third tier 408 indicates a deletion with the timestamp of Mar. 15, 2025, indicating Section 3 was deleted from Document A on Mar. 15, 2025.

In some examples, the hierarchical representation 402 includes a plurality of notices, such as a first notice 410A and a second notice 410B. In some examples, the notices are letters. In some examples, the notices 410A-B are linked to one or more nodes of the first tier 404. For example, the notices 410A-B can be linked to the first node 404A, such as when the notices 410A-B are associated with content corresponding to the first node 404A. For example, the notices 410A-B can be associated with a contract represented by the first node 404A. In some examples, the notices are letters or other documents that are associated with the document represented by the hierarchical representation 402, but are not part of the document itself. For example, notices or letters can be relevant to a product and/or service being provided by a contract, but without being part of the contract itself.

In some examples, the notices 410A-B can be linked to other nodes of the hierarchical representation 402, such as nodes 406A-C of the second tier 406 and/or nodes 408A-F of the third tier 408, such as when the notices 410A-B are associated with the content of those nodes.

In some examples, parent and child nodes in the hierarchical representation 402 are connected via an edge. In some examples, the user interface 400 can receive input from a user to edit the hierarchical representation 402. For example, a user can provide input to edit a label, category, and/or description of the nodes 404A, 406A-C, and/or 408A-F. In some examples, a user can perform zoom functions and/or scroll functions to navigate the hierarchical representation 402 on the user interface 400. In some examples, graphics of the user interface 400 are configurable by a user. For example, while the nodes 404A, 406A-C, and 408A-F are shown to include text descriptions in FIG. 4, in some examples the nodes 404A, 406A-C, and 408A-F can include numbers, colors, icons, animations, images, and/or other graphical representations.

FIG. 5 illustrates an example user interface 500, according to certain embodiments of the present disclosure. In some examples, the user interface 500 is a graphical user interface (GUI). In some examples, the user interface 500 is displayed on a computing device, such as the computing device 302 of FIG. 3.

In some examples, the GUI 500 includes key metrics 502, a list of contracts 504, and/or an amendment timeline 506. In some examples, the key metrics 502 include metrics about content stored in a document management system, such as one or more documents represented by the hierarchical representation 402 of FIG. 4. For example, the key metrics 502 can include how many contracts are in effect, how many clauses are being tracked across the documents in effect, and how many amendments have been made to the clauses being tracked.

In some examples, the list of contracts 504 includes a title of the contract (e.g., which party the contract is with), an effective date of the contract (e.g., an initial effective date and/or a most recent effective date), and a number of amendments that have been made to the contract (e.g., since the initial effective date).

In some examples, the amendments timeline 506 includes a graphical representation of when amendments have been made to a contract. In some examples, the amendments timeline 506 includes years, months, days, hours, minutes, business quarters, and/or another metric of time that may be recognized by those of ordinary skill in the art. In some examples, the amendments timeline 506 includes a plot for each of the contracts from the list of contracts 504. For example, the amendment timeline 506 includes a first plot for a first contract 512 with Corporation A and a second plot for a second contract 516 with Corporation B.

In some examples, the first plot for the first contract 512 includes a plurality of data points, such as a first data point 512A, a second data point 512B, and a third data point 512C. In some examples, the first data point 512A corresponds to the initial effective date of the contract with Corporation A. In some examples, the second data points 512B and the third data point 512C correspond to respective amendments to the contract with Corporation A. In some examples, the first data point 512A has a first size, shape, color, pattern, and/or graphic to visually differentiate from a second size, shape, color, pattern, and/or graphic of the second data point 512B and the third data point 512C, such as to visually distinguish the initial effective date from amendments on the first plot of the first contract 512. In some examples, a legend is provided to indicate which size, shape, color, pattern, and/or graphic corresponds to an initial effective date and which size, shape, color, pattern, and/or graphic corresponds to an amendment.

In some examples, the second plot for the second contract 516 includes a plurality of data points, such as a first data point 516A, a second data point 516B, and a third data point 516C. In some examples, the first data point 516A corresponds to the initial effective date of the contract with Corporation B. In some examples, the second data points 516B and the third data point 516C correspond to respective amendments to the contract with Corporation B. In some examples, the first data point 516A has a first size, shape, color, pattern, and/or graphic to visually differentiate from a second size, shape, color, pattern, and/or graphic of the second data point 516B and the third data point 516C, such as to visually distinguish the initial effective date from amendments on the second plot of the second contract 516. In some examples, a legend is provided to indicate which size, shape, color, pattern, and/or graphic corresponds to an initial effective date and which size, shape, color, pattern, and/or graphic corresponds to an amendment.

In some examples, one or more icons shown on the GUI 500 are selectable, such as to transition from the GUI 500 to another GUI (e.g., GUI 400, 600, 700, and/or 800). For example, a user may be able to select a contract from the list of contracts 504, and be able to view the contract or see additional details about the contract. In some examples, a user may be able to select data points (e.g., data points 512A-C and/or 516A-C) on the amendment timeline 506 to view the state of the contract at the given data point, what amendments were made at an amendment data point, and/or other information that may be recognized by those of ordinary skill in the art at least in view of the teachings provided herein.

FIG. 6 illustrates an example user interface 600, according to certain embodiments of the present disclosure. In some examples, the user interface 600 is a graphical user interface (GUI). In some examples, the user interface 600 is displayed on a computing device, such as the computing device 302 of FIG. 3. In some examples, a user can transition to the user interface 600 from another user interface described herein, such as the GUI 400, 500, 700, and/or 800 described with respect to FIGS. 4, 5, 7, and 8.

In some examples, the GUI 600 includes a header 602. For example, the header 602 includes a description of what contract is being viewed, how many clauses are in the contract, and how many amendments have been made to the contract.

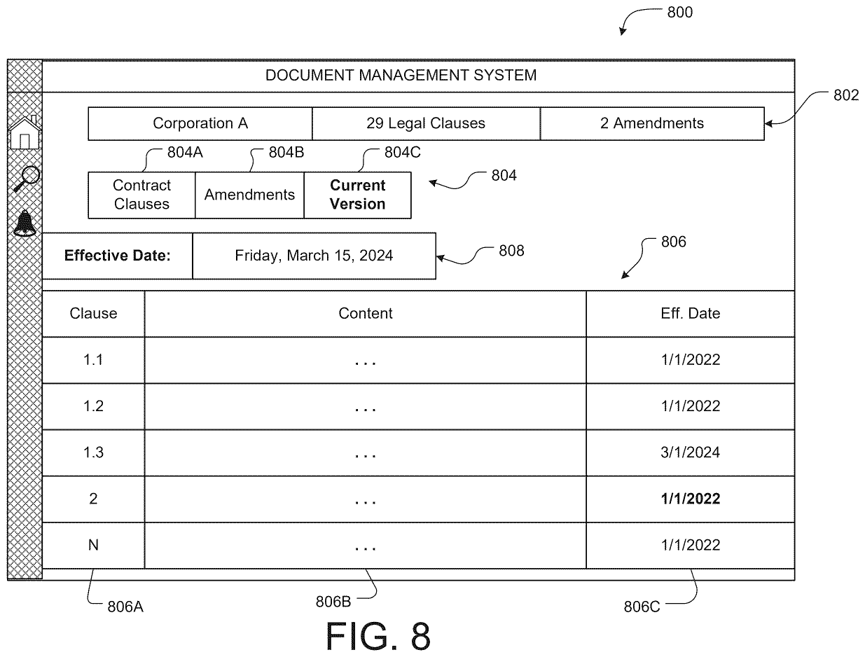

In some examples, the GUI 600 includes a page navigator 604. For example, the page navigator 604 includes a first selection option 604A, a second selection option 604B, and a third selection option 604C. In some examples, a user can provide input to the GUI 600 to select one of the first selection option 604A, second selection option 604B, and third selection option 604C to navigate to a page associated with the selected option. For example, GUI 700 described with respect to FIG. 7 can correspond to the second selection option 604B and GUI 800 described with respect to FIG. 8 can correspond to the third selection option 604C.

In some examples, the GUI 600 includes a table 606. In some examples, the table 606 includes a plurality of rows and columns. In some examples, the table 606 includes a first column 606A of clauses, a second column 606B with content of the corresponding clauses (e.g., text of the clause), a third column 606C with an effective date of the corresponding clauses, and a fourth column 606D indicating how many amendments have been made to the corresponding clauses.

In some examples the GUI 600 includes a document viewer and/or document editor 610. In some examples, the document editor 610 is configured to allow a user to view a live contract (e.g., an aggregation of all of the current clauses for a given date). In some examples, the document editor 610 is configured to allow a user to edit one or more clauses of the contract. In some examples, a user can type directly into the document editor 610 to amend one or more clauses and then save the amendment. In some examples, the saved amendment will be displayed in the document editor 610.

In some examples, the saved amendment from the document editor 610 is added to systems described herein as a new amendment, thereby updating the number of amendments in the table 606, updating the amendment timeline 506, updating the number of amendments shown in the list of contracts 504, updating the number of amendments made in the key metrics 502, and/or adding an amendment node (e.g., object) to the hierarchical representation 402 (e.g., in the third tier 408). Additional and/or alternative updates and/or additions made as a result of saving an amendment made via the document editor 610 should be recognized by those of ordinary skill in the art, at least in view of the teachings described herein.

FIG. 7 illustrates an example user interface 700, according to certain embodiments of the present disclosure. In some examples, the user interface 700 is a graphical user interface (GUI). In some examples, the user interface 700 is displayed on a computing device, such as the computing device 302 of FIG. 3. In some examples, a user can transition to the user interface 700 from another user interface described herein, such as the GUI 400, 500, 600, and/or 800 described with respect to FIGS. 4, 5, 6, and 8.

In some examples, the GUI 700 includes a header 702. For example, the header 702 includes a description of what contract is being viewed, how many clauses are in the contract, and how many amendments have been made to the contract.

In some examples, the GUI 700 includes a page navigator 704. For example, the page navigator 704 includes a first selection option 704A, a second selection option 704B, and a third selection option 704C. In some examples, a user can provide input to the GUI 700 to select one of the first selection option 704A, second selection option 704B, and third selection option 704C to navigate to a page associated with the selected option. For example, GUI 600 described with respect to FIG. 6 can correspond to the first selection option 704A and GUI 800 described with respect to FIG. 8 can correspond to the third selection option 704C.

In some examples, the GUI 700 includes a table 706. In some examples, the table 706 includes a plurality of rows and columns. In some examples, the table 706 includes a first column 706A of clauses, a second column 706B with old content for the corresponding clauses (e.g., text prior to an amendment being viewed on the GUI 700), a third column 706C updated content for the corresponding clauses (e.g., text after the amendment being viewed on the GUI 700), and a fourth column 706D with an AI-generated summary of the amendment. For example, the AI-generated summary can be provided by an LLM by prompting it to summarize the changes made to a given clause due to an amendment.

In some examples, the GUI 700 includes a graphical representation 708 of amendments made to a contract. For example, the graphical representation 708 can include an indication of when the initial contract was made, an indication of a first amendment to the initial contract, and an indication of a second amendment to the initial contract. In some examples, the graphical representation 708 includes dates, such as an effective date of an initial contract and/or an effective date of one or more amendments. In some examples, the graphical representation 708 includes different colors, shapes, patterns, sizes, and/or other graphical elements to distinguish between an initial contract and amendments to the initial contract being representation in the graphical representation 708. In some examples, aspects of the graphical representation 708 are selectable. For example, a first amendment illustrated by the graphical representation 708 can be selected and the selection can update the table 706 to correspond to the point in time at which the first amendment became effect (e.g., thereby updating the old content 706B, the updated content 706C, and/or the AI amendment summary). As another example, a second amendment illustrated by the graphical representation 708 can be selected and the selection can update the table 706 to correspond to the point in time at which the second amendment became effect.

In some examples the GUI 700 includes a document viewer and/or document editor 710. In some examples, the document editor 710 is the same as or similar to the document editor 610 described earlier herein with respect to GUI 600 of FIG. 6.

FIG. 8 illustrates an example user interface 800, according to certain embodiments of the present disclosure. In some examples, the user interface 800 is a graphical user interface (GUI). In some examples, the user interface 800 is displayed on a computing device, such as the computing device 302 of FIG. 3. In some examples, a user can transition to the user interface 800 from another user interface described herein, such as the GUI 400, 500, 600, and/or 700 described with respect to FIGS. 4, 5, 6, and 7.

In some examples, the GUI 800 includes a header 802. For example, the header 802 includes a description of what contract is being viewed, how many clauses are in the contract, and how many amendments have been made to the contract.

In some examples, the GUI 800 includes a page navigator 804. For example, the page navigator 804 includes a first selection option 804A, a second selection option 804B, and a third selection option 804C. In some examples, a user can provide input to the GUI 800 to select one of the first selection option 804A, second selection option 804B, and third selection option 804C to navigate to a page associated with the selected option. For example, GUI 600 described with respect to FIG. 6 can correspond to the first selection option 804A and GUI 700 described with respect to FIG. 7 can correspond to the second selection option 804B.

In some examples, the GUI 800 includes a table 706. In some examples, the table 706 includes a plurality of rows and columns. In some examples, the table 706 includes a first column 806A of clauses, a second column 806B with content for corresponding clauses at a given date (e.g., a user-input effective date), and a third column 706C indicating the effective date of the corresponding clauses.

In some examples, the GUI 800 includes a user-input feature 808. In some examples, the user-input feature 808 is configured to receive an effective date for a contract. For example, a user can type an effective date, dictate an effective date, select an effective date, and/or otherwise input an effective date into the GUI 800, via the user-input feature 808. In some examples, the table 806 is updated based on the effective date input into the user-input feature 808. For example, Clause 2 may have an amendment with an effective date of Feb. 1, 2025 (see FIG. 6); however, by selecting an effective date of Mar. 15, 2024 (which is before Feb. 1, 2025), the effective date for Clause 2 is Jan. 1, 2022 because that is the most recent effective date for Clause 2 as of Mar. 15, 2024. Additional and/or alternative examples of how changing the effective date via the user-input feature 808 can update one or more aspects of the GUI 800 should be recognized by those of ordinary skill in the art at least in light of the teachings provided herein.

In some embodiments, techniques disclosed herein include receiving a collection of documents. For example, the collection of documents can include an initial document with a plurality of sections and amendment documents that include amendments to one or more sections of the plurality of sections. Conventional systems and methods require a large amount of manual processing to format the documents and amendment documents in a way that allows a user to see what a current document is at a given point in time. In some examples, the collection of documents include a contract, a financial statement, a supply chain form, a marketing material, a book, an article, and/or another type of document that may be recognized by those of ordinary skill in the art as having a plurality of sections that may be amended over time.

In some embodiments, techniques disclosed herein include receiving a collection of contract documents. For example, the collection of contract documents can include an initial contract and amendments to the contract. Conventional systems and methods require a large amount of manual processing to format the contract documents and amendment documents in a way that allows a user to see what contract was actually in effect for a given point in time. In some embodiments, systems disclosed herein provided improved efficiency and accuracy for determining what contract was actually in effect for a given point in time, and allowing an improved user interface, such as for generating an exportable version of a live contract for the point in time with its in-effect clauses.

In some embodiments, systems disclosed herein receive (e.g., ingest) documents. In some embodiments, the documents are in a PDF format. In some embodiments, the documents can be in other electronic document formats recognized by those of ordinary skill in the art (e.g., JPEG, HEIC, DOC, DOCX, etc.). In some examples, the system takes the document and parses out information from the documents. In some examples, the system uses LLMs to figure out whether documents include an initial contract or an amendment. In some examples, the LLMs are further used to determine what clause(s) of an initial contract are being amended via a document including an amendment. In some examples, the LLM is used to indicate what a clause being amended is about and what the purpose of the amendment is.

In some examples, the system generates timestamps for the amended documents (e.g., as their effective date) along with the initial contract (e.g., as its effective date). In some examples, the system is able to generate a live version of the contract for a given point in time based on an ontology of the contract and its amendments constructed using the LLM.

In some examples, techniques provided herein include creating different objects for sections of a document (e.g., clauses of a contract) and amendments to the document. In some examples, using those different objects, techniques provided herein include creating live documents for given moments in time. In some examples, using the created objects and relationships between the objects, techniques provided herein are able to perform novel functionality.

In some examples, a “live document,” such as a “live contract” is a version of a document that is effective, controlling, and/or accurate for a given moment in time, when considering the initial document (e.g., contract) and subsequent amendments that have been implemented between the time of the initial document and the given moment in time. In some examples, the initial document can be amended in part at various points in time, making it difficult, if not impossible, to manually track what a live version of the document was at a particular moment in time.

In some examples, a document is a contract with ten different clauses. For example, the ten different clauses can include an indemnification clause. In some examples, a collection of ten amendments to the contract are received. In some examples, the collection of ten amendments includes three different versions of the indemnification clause. In some examples, the amendments from the collection of ten amendments that include different versions of the indemnification clause can be timestamped to determine at what moment in time a first version of the indemnification clause was effective, what moment in time a second version of the indemnification clause was effective, and what moment in time a third version of the indemnification clause was effective. For example, there can be multiple versions of a particular clause in the contract, and for each version there can be an associated timestamp of when that version became effective.

In some examples, a user can provide a query to the system asking what is the live version of a particular document (e.g., document in effect) on a particular date. In some examples, the query (or an indication thereof) can be provided to an LLM. In some examples, the LLM can access the document objects and amendment objects associated with the particular document and retrieve one or more of the clauses (e.g., all of the clauses) for the live version of the document on the particular date. In some examples, a user can provide a query asking what is the live version of a clause of a particular document on a particular date. In some examples, an LLM can access the document objects and amendment objects associated with the particular document and retrieve which clause was the live version on the particular date.

In some examples, the system can deterministically evaluate timestamps associated with stored document objects and amendment objects to determine the live version of a clause and/or full document. In some examples, the system can use an LLM with an AI agent that allows users to chat with the system regarding particular documents which the LLM and AI agent can then interact with document objects and amendment objects related thereto to respond to user prompts.

In some examples, the LLM can determine the semantic meaning of a particular clause of a document and/or the overall document. For example, the LLM can determine whether a particular clause is an indemnification clause, a forum selection clause, a consideration clause, a party description clause, and/or another type of clause that may be recognized by those of ordinary skill in the art. In some examples, the LLM can recognize who are the parties to a contract and what the contract is generally about (e.g., a service agreement, a product sale, etc.).

In some examples, when documents are received by the system, an OCR process and/or computer vision process is/are applied to the documents to extract text from the documents. In some examples, the extracted text is provided to an LLM to classify whether the extracted text forms an initial contract or an amendment to a contract. In some examples, after the classification, the system creates data objects in an ontology to represent the classified extracted text with timestamps corresponding to an effective time (e.g., date) of the initial contract and/or amendment.

For example, if a collection of documents includes two initial contracts and six amendments (three for each contract), then the system may OCR the collection of documents, and provide the collection of documents to the LLM to be classified. Also for example, once the collection of documents are classified, an initial contract object may be created for each of the initial contracts, and amendment objects may be created for each of the amendment objects. In some examples, the initial contract objects and amendment objects may have relationships indicating to which initial contract the amendments are amending.

In some examples, a hierarchical representation of the initial contract and the amnedments to the contract can be displayed. For example, a timeline can be displayed including the effective date of the initial contract and then the effective date of the amendments to the contract. As another example, a table can be provided including version numbers for a particular clause, the language of the clause, and/or a summary of amendments to the clause.

In some examples, attributes of received documents can be determined and/or tracked. For example, the attributes can include whether a document is a contract, parties to the contract, how many clauses are in the contract, how many subclauses are associated with each clause, and/or what the clauses and/or subclauses in the contract are about. Additional and/or alternative attributes of the received documents that can be determined and/or tracked should be recognized by those of ordinary skill in the art.

In some examples, unique identifiers are generated and assigned to each contract. In some examples, each contract is represented by a unique identifier, such as to track amendments to the contract via the unique identifier. In some examples, a clause can be added to the contract via an amendment. In some examples, a clause can be removed from the contract via an amendment. In some examples, a clause can be revised in the contract via an amendment. In some examples, the system flags whether an amendment includes an addition, a removal, and/or a revision to a clause. For example, if a clause is removed via an amendment then it can be flagged as removed effective on the date of the amendment, such that the clause is not included in a live version of the contract on/after the effective date.

In some examples, the system detects a degree of visual quality of received documents. For example, the system can detect whether a document is able to be OCR'ed. As another example, the system can rerun an OCR process several times and determine which OCR is the most accurate (e.g., according to an LLM reading the OCR'ed document, according to how similar different iterations of an OCR process are to each other, etc.).

In some examples, received documents can include documents other than initial contracts or amendments. For example, the received documents can include notices or letters that are related to a contract, but do not actually form part of the contract. In some examples, links to the notices and letters can be stored in/with data objects corresponding to the contracts for which they are associated, so that a user/system can easily access and/or reference the notices and letters. In some examples, an LLM can be used to determine the notices and letters are semantically more similar to one contract as compared to another contract(s), for the system to conclude the notices and letters should be linked to the one contract, as compared to the other contract(s).

In some examples, the ontology structure disclosed herein includes a respective object for each initial contract. In some examples, the ontology structure includes a respective object for each initial clause of a contract. In some examples, each initial clause object has a relationship (e.g., parent/child relationship) to the initial contract object of which they are a part. In some examples, the ontology structure includes a respective amendment object for each amendment to a contract. In some examples, each amendment object has a relationship (e.g., parent/child relationship) to the initial clause(s) that they amend. In some examples, the objects are linked to the documents they represent (e.g., an amendment object can be linked to the amendment document it represents). In some examples, the objects are linked to supplemental documents (e.g., notices, letters, etc.) that are related to the objects, but which the objects do not directly represent.

In some examples, each document is provided to the LLM to classify what kind of document it is (e.g., a contract, an amendment, a notice, a letter, etc.). In some examples, based on the classification, a particular parsing process may be applied to the document. For example, a first parsing process may be applied to a contract and a second parsing process different than the first parsing process may be applied to the amendment, such as to improve accuracy for particular types of formats that may be expected in each type of document.

In some examples, the ontology structure breaks down to the clause-level, such that processing can be performed on the clause-level. In some examples, clause objects are created for subclauses, so that subclauses are also represented individually in the ontology.

In some examples, techniques disclosed herein create structured data structures for unstructured information from disparate data sources. In some examples, these novel data structures for traditionally unstructured data from disparate data sources allows for complex downstream processing that could not otherwise be implemented on the conventionally unstructured data.

In some examples, techniques herein include processes to prevent hallucinations in the use of LLMs. For example, using prompt engineering, the LLMs can be provided clear enough instructions to operate with a relatively high degree of accuracy. For example, the prompts can be written to address and correct problems that previously led to hallucinations, such that the hallucinations do not occur again.

In some examples, techniques disclosed herein use retrieval augmented generation (RAG). For example, the system can use RAG for document generation, such as for creating live documents by retrieving all of the different live clauses for a document given a particular effective date. In some examples, the system can use RAG to retrieve documents associated with a live document and/or with a query associated with a document, such as to accurately address a user's prompt regarding the document.

In some examples, the ontology described herein enables certain chat functionalities, such as by further using LLMs. In some examples, systems disclosed herein include an artificial intelligence agent setup that users can converse with via a graphical user interface. In some examples, the artificial intelligence agent has access to the ontology (e.g., to retrieve and/or edit the ontology). In some examples, the artificial intelligence agent is provided with instructions on how the ontology is structured to be able to access the different data objects in the ontology.

In some examples, the ontology structure has links in each data object that allows the system to retrieve the document the data object represents and/or related documents to the data object. For example, when the AI agent gives a response about a particular document based on the document's data object, it may then know what document identifier is related to that response and be able to retrieve the document that is paired to the document identifier.

In some examples, an LLM is used to classify documents, summarize the documents, and determine how many clauses are in the documents, but the system can then use this output from the LLM to create data objects for the documents in a particular data structure to map the documents to the ontology described herein.

In some examples, an LLM can be prompted to summarize aspects of the data structure formed by the data objects, such as to summarize what a particular data object is about, how it differs from other data objects, or the like. For example, the LLM can summarize how a first version of a clause is different than a second version of the clause based on the respective data objects for the versions of the clause and/or their identifiers that link to the underlying documents used to create the respective data objects for the versions of the clause. In some examples, the data structure is a hierarchical representation.

In some examples, an LLM can receive the data structure (e.g., hierarchical representation) and use the data structure to perform functions, such as responding to queries regarding one or more aspects of the data structure. In some examples, the LLM can use the data structure and RAG to access documents related to objects stored in the data structure.

In some examples, the LLM can be used to generate the live document based on effective dates of an initial document and amendments to the initial document. In some examples, the live document can be generated deterministically, where a user can select a date and have the system automatically calculate which parts of a document are effective on a given date, in view of amendment documents.

In some examples, objects in the data structure can be associated with (e.g., linked to) one or more documents. For example, an amendment object can be associated with (e.g., linked to) an amendment document based on which the amendment object was generated. In some examples, an object in the data structure can be associated with one or more other types of documents, such as a notice document, a letter document, an invoice document, an order document, a contact, an email, and/or another type of document related to the object in the data structure that may be recognized by those of ordinary skill in the art. For example, an amendment to a contract may be the result of an email and/or an order from a customer, such that an amendment object corresponding to the amendment to the contract can be linked to the amendment, as well as the email and/or the order from the customer.

In some examples, an amendment to a contract includes a change in the quantity of items purchased in the contract. In some examples, the amendment includes a change in the cost of items purchased in the contract. In some examples, the items include goods. In some examples, the items include services. In some examples, if there are multiple amendments that conflict with each other, but are both supposed to be in effect, then the system can flag the conflict. For example, the system can generate a notification to communicate to a user there is a conflict in the amendments that needs to be resolved.

In some examples, ontology described herein can be displayed to a user as a hierarchical representation on a graphical user interface (GUI). For example, the hierarchical representation can be a graph with parent/child nodes. In some examples, the user can interact with the GUI, such as to select what information regarding the ontology is displayed, to edit the ontology, and/or to request answers to queries regarding the ontology.

In some examples, the GUI includes a list of documents (e.g., contracts). In some examples, the GUI includes how many contracts are active, how many contracts are expired, how many clauses are in each contract, how many amendments have been made to the clauses, and/or summaries associated with the contracts.

In some examples, the GUI includes a timeline of amendments made to an initial document. In some examples, the initial document is represented on the timeline with a first icon and amendments to the initial document are represented with one or more second icons. In some examples, the first icon includes a first color, pattern, and/or graphic and the one or more second icons include a second color, pattern, and/or graphic different than the first icon (e.g., to visually distinguish between the initial document represented on the timeline and the amendments represented on the timeline).

In some examples, the first icon and/or the one or more second icons are selectable. For example, when selected, the GUI can display additional information related to the first icon and/or the one or more second icons that were selected. In some examples, the GUI includes an input feature to request that a live document is generated. For example, the input feature can include a button, a text box, a drop down menu, and/or another type of input feature that may be recognized by those of ordinary skill in the art. For example, a user can request that a live document be generated for a particular date (e.g., an effective date), and in response, the GUI can display the live document for the particular date. For example, if the document is a contract, the system can pull the appropriate clauses for the document that are filtered by the effective date, and construct the live document by appending the effective clauses together in their correct order.

In some examples, the GUI includes an option to view a section history for a document. For example, the section history can include an option to view an original section of a document, as well as how the original section has been amended over time. In some examples, a user can provide a prompt to the system to request a summary of how the section has been amended (e.g., over a duration of time). In certain examples, the system can provide the prompt and the ontology of the document to an LLM to provide the requested summary of how the section has been amended, in natural language.

In some examples, the GUI includes an AI chat feature that allows the user to provide prompts regarding a document and/or its section. For example, the user can provide prompts requesting summaries, answers to questions, quotes from documents, and/or other types of prompts that may be recognized by those of ordinary skill in the art. In some examples, the system can provide the prompt and the ontology of the document to an LLM to provide responses to the prompts. In some examples, the AI chat feature interfaces with one or more agentic AI systems that can take actions based on the user's prompts. For example, the agentic AI systems can generate emails, retrieve documents, place orders, send notifications, and/or take other actions that may be recognized by those of ordinary skill in the art.

In some examples, a user can provide input to the GUI to view and/or edit documents linked to objects in the hierarchical representation (e.g., amendment documents, order forms, emails, notices, letters, etc.). In some examples, the GUI includes notifications for when one or more documents have been rejected (such as due to low visual quality). In some examples, the GUI includes notifications for when one or more documents linked to objects in the hierarchical representation cannot be located. For example, a user may upload an amendment to a document without uploading the initial document, such that the initial document cannot be retrieved. In some examples, a user can, in response to viewing the notifications, take action to resolve issues in the notifications. For example, the user can upload documents to the system that could not be found and/or upload high visual quality versions of documents that were flagged to have low visual quality.

In some examples, systems disclosed herein include an internal writeback function. For example, a user can select a section of a document and edit the section via the system. In some examples, the internal writeback function allows a user to create their own amendment in the system without needing to upload and OCR an amendment document. In some examples, the amendment generated via internal writeback is classified by an LLM, as if it were uploaded as an amendment document. In some examples, the amendment generated via internal writeback has an object generated based on it, to be included in the hierarchical representation, as if it were uploaded as an amendment document. In some examples, the object generated based on the amendment from internal writeback may not be linked to an uploaded document, different than the objects generated based on uploaded amendment documents, such as because the amendment from internal writeback was not generated based on an uploaded document to be linked to it.

In some examples, the hierarchical representation includes document objects, document section objects, and amendment objects. In some examples, a document object is in a parent/child relationship with the document section objects corresponding to the document object. In some examples, the document section objects are in a parent/child relationship with the amendment objects corresponding to the respective document section objects. In some examples, external media can be linked to the document objects, document section objects, and/or amendment objects. For example, the external media can include the underlying documents based on which the respective objects were generated. As another example, the external media can include associated documents, such as order forms, emails, contacts, notices, letters, and/or other associated documents that should be recognized by those of ordinary skill in the art.

In some examples, the amendment objects are stored in the hierarchical representation as document section objects, but with links indicating to which document section objects the amendment objects are associated (e.g., based on which document sections are being amended).

In some examples, techniques provided herein solve the technical problem of dealing with unstructured data from disparate data sources. For example, conventional techniques are unreliable at structuring a collection of documents that include an initial document with a plurality of sections and amendment documents that apply to some of the plurality of sections across different periods of time. In some examples, by reliably structuring the previously unstructured data, novel technical functions can be implemented, such as generating timelines, searching live documents from particular moments in time, summarizing live documents and/or changes between live documents from different periods of time, and/or integrating AI agentic functionality to take downstream actions.

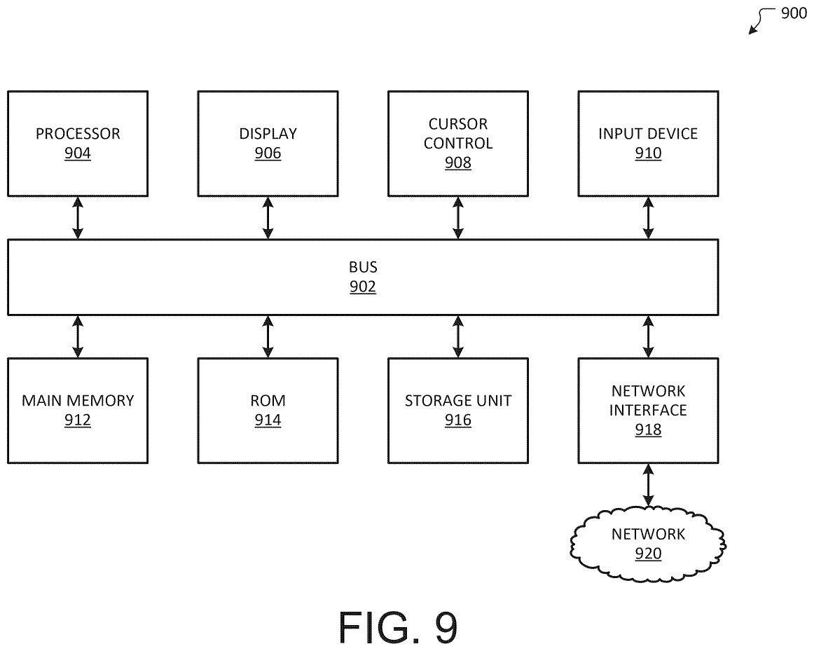

FIG. 9 is a simplified diagram showing a computing system for implementing a system 900 for managing documents with revisions in accordance with at least one example set forth in the disclosure. This diagram is merely an example, which should not unduly limit the scope of the claims. One of ordinary skill in the art would recognize many variations, alternatives, and modifications.

The computing system 900 includes a bus 902 or other communication mechanism for communicating information, a processor 904, a display 906, a cursor control component 908, an input device 910, a main memory 912, a read only memory (ROM) 914, a storage unit 916, and a network interface 918. In some embodiments, some or all processes (e.g., steps) of methods and/or processes disclosed herein are performed by the computing system 900. In some embodiments, the bus 902 is coupled to the processor 904, the display 906, the cursor control component 908, the input device 910, the main memory 912, the read only memory (ROM) 914, the storage unit 916, and/or the network interface 918. In certain embodiments, the network interface is coupled to a network 920. For example, the processor 904 includes one or more general purpose microprocessors. In some embodiments, the main memory 912 (e.g., random access memory (RAM), cache and/or other dynamic storage devices) is configured to store information and instructions to be executed by the processor 904. In certain embodiments, the main memory 912 is configured to store temporary variables or other intermediate information during execution of instructions to be executed by processor 904. For example, the instructions, when stored in the storage unit 916 accessible to processor 904, render the computing system 900 into a special-purpose machine that is customized to perform the operations specified in the instructions. In some embodiments, the ROM 914 is configured to store static information and instructions for the processor 904. In certain embodiments, the storage unit 916 (e.g., a magnetic disk, optical disk, or flash drive) is configured to store information and instructions.

In some embodiments, the display 906 (e.g., a cathode ray tube (CRT), an LCD display, or a touch screen) is configured to display information to a user of the computing system 900. In some embodiments, the input device 910 (e.g., alphanumeric and other keys) is configured to communicate information and commands to the processor 904. For example, the cursor control component 908 (e.g., a mouse, a trackball, or cursor direction keys) is configured to communicate additional information and commands (e.g., to control cursor movements on the display 906) to the processor 904.

According to certain embodiments, a method for generating a hierarchical representation of document versions is provided. In some examples, the method includes receiving a document. In some examples, the document includes one or more sections. In some examples, each section of the one or more sections has one or more text strings. In some examples, the method includes identifying a document classification associated with the document, selecting a hierarchical data model based on the document classification, generating a request based on the document and an indication of the hierarchical data model, providing the request to a large language model, and receiving a hierarchical representation corresponding to the document from the large language model. In some examples, the hierarchical representation includes an indication of a document object and one or more section objects. In some examples, each section object of the one or more section objects is linked to the document object. In some examples, each section object includes data associated with a respective section of the one or more sections. In some examples, the method is performed using one or more processors. For example, the method is implemented according to at least FIG. 1, FIG. 2, FIG. 3, FIG. 4, FIG. 5, FIG. 6, FIG. 7, FIG. 8, and/or FIG. 9.

In some examples, the document is a second document that is a revision of a first document, and the hierarchical representation includes a revision object that is linked to at least one of the one or more section objects. In some examples, the revision object is linked to the document object. In some examples, the selecting a hierarchical data model includes generating the hierarchical data model based on the document and the document classification.

In some examples, the document is for a contract and each section of the one or more sections is a respective clause of the contract. In some examples, the method further includes receiving a request for a current version of the contract at a given date, generating, based on the hierarchical representation, the current version of the contract, on the given date, and providing a representation of the current version of the contract on the given date.

In some examples, the method further includes causing displaying a graphical user interface including information about the document based on the hierarchical representation. In some examples, the information displayed on the graphical user interface includes a timeline of one or more amendments made to the document. In some examples, the information further includes one or more summaries describing the one or more amendments made to the document. In some examples, the one or more summaries are generated by the large language model.

In some examples, the method further includes, prior to identifying the document classification associated with the document: determining a visual quality level of the document, comparing the visual quality level to a predetermined threshold, and prompting, based on the comparing, a user to provide a new version of the document with a higher visual quality level than the visual quality level.

In some examples, the method further includes receiving a query regarding the document from a computing device, providing the hierarchical representation and the query to the large language model, receiving from the large language model a response to the query, and providing the response to the query to the computing device.

According to certain embodiments, a system for generating a hierarchical representation of document versions is provided. In some examples, the system includes one or more processors and one or more memories storing instructions that, when executed by the one or more processors, cause the system to perform a set of operations. In some examples, the set of operations includes receiving a document. In some examples, the document includes one or more sections. In some examples, each section of the one or more sections has one or more text strings. In some examples, the set of operations includes identifying a document classification associated with the document, selecting a hierarchical data model based on the document classification, generating a request based on the document and an indication of the hierarchical data model, providing the request to a large language model, and receiving a hierarchical representation corresponding to the document from the large language model. In some examples, the hierarchical representation includes an indication of a document object and one or more section objects. In some examples, each section object of the one or more section objects is linked to the document object. In some examples, each section object includes data associated with a respective section of the one or more sections. For example, the system is implemented according to at least FIG. 1, FIG. 2, FIG. 3, FIG. 4, FIG. 5, FIG. 6, FIG. 7, FIG. 8, and/or FIG. 9.

In some examples, the document is a second document that is a revision of a first document, and the hierarchical representation includes a revision object that is linked to at least one of the one or more section objects. In some examples, the revision object is linked to the document object. In some examples, the selecting a hierarchical data model includes generating the hierarchical data model based on the document and the document classification.

In some examples, the document is for a contract and each section of the one or more sections is a respective clause of the contract. In some examples, the set of operations further includes receiving a request for a current version of the contract at a given date, generating, based on the hierarchical representation, the current version of the contract, on the given date, and providing a representation of the current version of the contract on the given date.

In some examples, the set of operations further includes causing displaying a graphical user interface including information about the document based on the hierarchical representation. In some examples, the information displayed on the graphical user interface includes a timeline of one or more amendments made to the document. In some examples, the information further includes one or more summaries describing the one or more amendments made to the document. In some examples, the one or more summaries are generated by the large language model.

In some examples, the set of operations further includes, prior to identifying the document classification associated with the document: determining a visual quality level of the document, comparing the visual quality level to a predetermined threshold, and prompting, based on the comparing, a user to provide a new version of the document with a higher visual quality level than the visual quality level.

In some examples, the set of operations further includes receiving a query regarding the document from a computing device, providing the hierarchical representation and the query to the large language model, receiving from the large language model a response to the query, and providing the response to the query to the computing device.

According to certain embodiments, a non-transitory computer-readable storage medium including instructions that when executed by one or more processors cause the one or more processors to perform a set of operations is provided. In some examples, the set of operations includes receiving a document. In some examples, the document includes one or more sections. In some examples, each section of the one or more sections has one or more text strings. In some examples, the set of operations includes identifying a document classification associated with the document, selecting a hierarchical data model based on the document classification, generating a request based on the document and an indication of the hierarchical data model, providing the request to a large language model, and receiving a hierarchical representation corresponding to the document from the large language model. In some examples, the hierarchical representation includes an indication of a document object and one or more section objects. In some examples, each section object of the one or more section objects is linked to the document object. In some examples, each section object includes data associated with a respective section of the one or more sections. For example, the system is implemented according to at least FIG. 1, FIG. 2, FIG. 3, FIG. 4, FIG. 5, FIG. 6, FIG. 7, FIG. 8, and/or FIG. 9.

In some examples, the document is for a contract and each section of the one or more sections is a respective clause of the contract.

For example, some or all components of various embodiments of the present disclosure each are, individually and/or in combination with at least another component, implemented using one or more software components, one or more hardware components, and/or one or more combinations of software and hardware components. In an example, some or all components of various embodiments of the present disclosure each are, individually and/or in combination with at least another component, implemented in one or more circuits, such as one or more analog circuits and/or one or more digital circuits. In an example, while the embodiments described above refer to particular features, the scope of the present disclosure also includes embodiments having different combinations of features and embodiments that do not include all of the described features. In an example, various aspects of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods'operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be removed from the combination, and a combination may, for example, be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for generating a hierarchical representation of document versions, the method comprising:
receiving a document, the document including one or more sections, each section of the one or more sections having one or more text strings;
identifying a document classification associated with the document;
selecting a hierarchical data model based on the document classification;
generating a request based on the document and an indication of the hierarchical data model;
providing the request to a large language model; and
receiving a hierarchical representation corresponding to the document from the large language model, the hierarchical representation including an indication of a document object and one or more section objects, each section object of the one or more section objects being linked to the document object, each section object including data associated with a respective section of the one or more sections,
wherein the method is performed using one or more processors.

2. The method of claim 1, wherein the document is a second document that is a revision of a first document, and wherein the hierarchical representation includes a revision object that is linked to at least one of the one or more section objects.

3. The method of claim 2, wherein the revision object is linked to the document object.

4. The method of claim 1, wherein the selecting a hierarchical data model includes generating the hierarchical data model based on the document and the document classification.

5. The method of claim 1, wherein the document is for a contract, and wherein each section of the one or more sections is a respective clause of the contract.

6. The method of claim 5, further comprising:
receiving a request for a current version of the contract at a given date;
generating, based on the hierarchical representation, the current version of the contract, on the given date; and
providing a representation of the current version of the contract on the given date.

7. The method of claim 1, further comprising:
causing displaying a graphical user interface comprising information about the document based on the hierarchical representation.

8. The method of claim 7, wherein the information displayed on the graphical user interface comprises a timeline of one or more amendments made to the document.

9. The method of claim 8, wherein the information further comprises one or more summaries describing the one or more amendments made to the document, and wherein the one or more summaries are generated by the large language model.

10. The method of claim 1, further comprising, prior to identifying the document classification associated with the document:
determining a visual quality level of the document;
comparing the visual quality level to a predetermined threshold; and
prompting, based on the comparing, a user to provide a new version of the document with a higher visual quality level than the visual quality level.

11. The method of claim 1, further comprising:
receiving a query regarding the document from a computing device;
providing the hierarchical representation and the query to the large language model;
receiving from the large language model a response to the query; and
providing the response to the query to the computing device.

12. A system for generating a hierarchical representation of document versions, the system comprising:
one or more processors; and
one or more memories storing instructions that, when executed by the one or more processors, cause the system to perform a set of operations, the set of operations comprising:
receiving a document, the document including one or more sections, each section of the one or more sections having one or more text strings;
identifying a document classification associated with the document;
selecting a hierarchical data model based on the document classification;
generating a request based on the document and an indication of the hierarchical data model;
providing the request to a large language model; and
receiving a hierarchical representation corresponding to the document from the large language model, the hierarchical representation including an indication of a document object and one or more section objects, each section object of the one or more section objects being linked to the document object, each section object including data associated with a respective section of the one or more sections.

13. The system of claim 12, wherein the document is a second document that is a revision of a first document, and wherein the hierarchical representation includes a revision object that is linked to at least one of the one or more section objects.

14. The system of claim 13, wherein the revision object is linked to the document object.

15. The system of claim 12, wherein the selecting a hierarchical data model includes generating the hierarchical data model based on the document and the document classification.

16. The system of claim 12, wherein the document is for a contract, and wherein each section of the one or more sections is a respective clause of the contract.

17. The system of claim 16, wherein the set of operations further comprises:
receiving a request for a current version of the contract at a given date;
generating, based on the hierarchical representation, the current version of the contract, on the given date; and
providing a representation of the current version of the contract on the given date.

18. The system of claim 12, wherein the set of operations further comprises:
receiving a query regarding the document from a computing device;
providing the hierarchical representation and the query to the large language model;
receiving from the large language model a response to the query; and
providing the response to the query to the computing device.

19. A non-transitory computer-readable storage medium comprising instructions that when executed by one or more processors cause the one or more processors to perform a set of operations comprising:
receiving a document, the document including one or more sections, each section of the one or more sections having one or more text strings;
identifying a document classification associated with the document;
selecting a hierarchical data model based on the document classification;
generating a request based on the document and an indication of the hierarchical data model;
providing the request to a large language model; and
receiving a hierarchical representation corresponding to the document from the large language model, the hierarchical representation including an indication of a document object and one or more section objects, each section object of the one or more section objects being linked to the document object, each section object including data associated with a respective section of the one or more sections.

20. The non-transitory computer-readable storage medium of claim 19, wherein the document is for a contract, and wherein each section of the one or more sections is a respective clause of the contract.
